(19) United States
(12) Patent Application Publication
(10) Pub. No.: US 2025/0236213 A1
(43) Pub. Date: Jul. 24, 2025

(54) CENTER SEAT MOUNTING STRUCTURE

(71) Applicants: HYUNDAI MOTOR COMPANY, Seoul (KR); KIA CORPORATION, Seoul (KR)

(72) Inventor: Youngjun Kim, Hwaseong-si (KR)

(73) Assignees: HYUNDAI MOTOR COMPANY, Seoul (KR); KIA CORPORATION, Seoul (KR)

(21) Appl. No.: 18/961,128

(22) Filed: Nov. 26, 2024

(30) Foreign Application Priority Data
Jan. 18, 2024 (KR) 10-2024-0008144

(51) Int. Cl. B60N 2/015; B60N 2/01

(52) U.S. Cl. CPC B60N 2/015; B60N 2/012

(57) ABSTRACT

A center seat mounting structure includes a floor panel forming a tunnel portion in a length direction of a vehicle body and forming seat cross members arranged on the floor panel in a width direction of the vehicle body on both sides of the tunnel portion. The center seat mounting structure also includes a connecting member that connects the seat cross members on both sides and forms a center seat mounting portion.

### CROSS-REFERENCE TO RELATED APPLICATION

This application claims priority to and the benefit of Korean Patent Application No. 10-2024-0008144 filed in the Korean Intellectual Property Office on Jan. 18, 2024, the entire contents of which are incorporated herein by reference.

### BACKGROUND OF THE DISCLOSURE

### (a) Technical Field

The present disclosure relates to a center seat mounting structure. More particularly, the present disclosure relates to a center seat mounting structure that can be commonly employed in a vehicle with a center seat mounted in the vehicle and in a vehicle without a center seat mounted in the vehicle.

### (b) Description of the Related Art

Some consumers of midsize or large vehicles, particularly midsize or large sport utility vehicles (SUVs), may require an additional center seat between the driver's seat and the side seats in the first row of seats.

Depending on the vehicle type, there are cases where an integrated seat mounting bracket that engages the side seat and center seat is installed or employed as a configuration for mounting the first row center seat.

However, since not all consumers want to include the center seat in the first row, an integrated bracket exists even in models without a center seat. This increases the total weight of the vehicle and may increase production costs in models without a center seat.

Subject matter described in this background section is provided to enhance understanding of the background of the disclosure. Therefore, the background section may include subject matter other than conventional or prior art already known to a person of ordinary skill in the field to which this disclosure belongs.

### SUMMARY OF THE DISCLOSURE

The present disclosure provides a center seat mounting structure that minimizes the need for a separate member for mounting the center seat.

In addition, the present disclosure provides a center seat mounting structure that utilizes a general first row 2-seater vehicle body platform structure and enables cost and weight reduction by employing or requiring a minimum number of separate members.

In addition, the present disclosure provides a center seat mounting structure that can satisfy regulations regarding seat belt anchors by securing the strength of the structure or component configuration for mounting the center seat. A center seat mounting structure according to an embodiment of the present disclosure may include a floor panel forming a tunnel portion arranged in a length direction of a vehicle body and forming seat cross members arranged on the floor panel in a width direction of the vehicle body on both sides of the tunnel portion. The center seat mounting structure may also include a connecting member that connects the seat cross members on both sides and forms a center seat mounting portion.

The seat cross member may include a front seat cross member arranged on each side of the tunnel portion and may include a rear seat cross member disposed on each side of the tunnel portion rearward of the front seat cross member relative to the length direction of the vehicle body.

The connecting member may include a front connecting member connecting the front seat cross members on both sides and may include a rear connecting member that connects the rear seat cross members on both sides.

The center seat mounting structure according to an embodiment may further include a tunnel reinforcement arranged in the length direction of the vehicle body on the upper portion of the tunnel portion to form a tunnel portion closed space together with the tunnel portion.

The front connecting member may include a center seat front bracket in which a front center seat mounting portion is formed and connected to the front seat cross members on both sides.

The front connecting member may further include a center seat front reinforcement that is arranged in the width direction of the vehicle body to support the center seat front bracket and that is connected to the tunnel reinforcement.

The center seat mounting structure according to an embodiment may further include a front tunnel patch connected to the tunnel reinforcement and supporting the center seat front reinforcement.

The front tunnel patch may extend in forward direction relative to a front of the vehicle body.

The center seat mounting structure according to an embodiment may further include a front tunnel brace disposed at the lower part of the tunnel portion, connecting the lower parts of both sides of the tunnel portion, and placed in the same width direction phase as the front seat cross member.

The rear connecting member may further include a center seat rear member, which is disposed on the tunnel reinforcement, to which a rear center seat mounting portion is formed, and to which the rear seat cross members on both sides are connected.

The center seat rear member may be formed to have a center seat mount guide hole.

The center seat mounting structure according to an embodiment may further include a rear seat bracket connecting the center seat rear member and the rear seat cross member.

The rear connecting member may further include a center seat rear reinforcement supporting the center seat rear member.

The center seat mounting structure according to an embodiment may further include a rear tunnel patch connected to the tunnel reinforcement to support the center seat rear member.

The rear tunnel patch may extend beyond the longitudinal length of the center seat rear member and may be arranged or oriented in the length direction of the vehicle body.

The center seat mounting structure according to an embodiment may further include a rear tunnel brace that is positioned at the lower portion of the tunnel portion, connects the lower portions of both sides of the tunnel portion, and is positioned in the same width direction phase as the rear seat cross member.

The center seat mounting structure according to an embodiment can minimize the need for a separate member for mounting the center seat.

The center seat mounting structure according to an embodiment utilizes a general first row 2-seater vehicle body platform structure and can reduce cost and weight by employing or requiring a minimum number of separate members, parts, or components.

The center seat mounting structure according to an embodiment can satisfy regulations regarding seat belt anchors by securing the strength of a structure or component configuration for mounting a center seat.

In addition, the effects that can be obtained or expected from embodiments of the present disclosure are directly or implicitly disclosed in the detailed description of the embodiments of the present disclosure. In other words, various effects that may be expected of a structure according to embodiments of the present disclosure are disclosed in or may be ascertainable from the detailed description provided below.

### BRIEF DESCRIPTION OF THE DRAWINGS

Since the drawings are for reference in explaining embodiments of the present disclosure, the technical ideas of the present disclosure should not be construed as being limited to the accompanying drawings.

FIG. 1 is a top plan view of a center seat mounting structure according to an embodiment.

FIG. 2 is a perspective view of a front of a center seat mounting structure according to an embodiment.

FIG. 3 is a perspective view of a center seat front reinforcement that may be used in a center seat mounting structure according to an embodiment.

FIG. 4 is a perspective view of a front tunnel brace that may be used in a center seat mounting structure according to an embodiment.

FIG. 5 is a cross-sectional view along line V-V of the center seat mounting structure of FIG. 2.

FIG. 6 is a cross-sectional view along line VI-VI of the center seat mounting structure of FIG. 2.

FIG. 7 is a cross-sectional view along line VII-VII of the center seat mounting structure of FIG. 2.

FIG. 8 is a partial perspective view of a front portion of a center seat mounting structure according to an embodiment.

FIG. 9 is a perspective view of a front portion of a center seat mounting structure according to an embodiment.

FIG. 10 is a partial exploded perspective view of a front portion of a center seat mounting structure according to an embodiment.

FIG. 11 is a perspective view of a rear tunnel brace that may be used in a center seat mounting structure according to an embodiment.

FIG. 12 is a cross-sectional view along line XII-XII of the center seat mounting structure of FIG. 9.

FIG. 13 is a cross-sectional view along line XIII-XIII of the center seat mounting structure of FIG. 9.

FIG. 14 is a cross-sectional view along line XIV-XIV of the center seat mounting structure of FIG. 9.

FIG. 15 is a partial perspective view of a rear portion of a center seat mounting structure according to an embodiment.

The drawings referenced above are not necessarily drawn to scale, and thus should be understood as presenting a somewhat simplified representation of various features illustrating the basic principles of the present disclosure. The specific design features of the disclosure, including, for example, specific dimensions, orientation, location, and shape, will be determined in part by the particular intended application and usage environment.

### DETAILED DESCRIPTION OF THE EMBODIMENTS

Hereinafter, with reference to the attached drawings, embodiments of the present disclosure are described in detail so that those of ordinary skill in the art can understand and implement the present disclosure.

As those of ordinary skill in the art should realize, the described embodiments may be modified in various different ways, all without departing from the spirit or scope of the present disclosure.

In order to clearly explain the technical ideas of the present disclosure, parts irrelevant to the description have been omitted and the same reference numerals are used for identical or similar components throughout the specification.

The size and thickness of each component shown in the drawings are arbitrarily shown for convenience of explanation. The present disclosure is not necessarily limited to what is shown in the drawings. In order to clearly express various parts and areas, the thickness may be shown by enlarging it.

In addition, the names of the components in the detailed description below may be distinguished as first, second, etc., to distinguish them from like components and the description below is not necessarily limited to that order.

Throughout the specification, whenever a part is said to include or comprises a certain component, this does not mean that it excludes other components, but rather that it may include other components, unless otherwise specifically stated.

Additionally, terms such as “means”, “portion”, “part”, “unit”, etc., described in the specification mean a comprehensive unit that performs or is configured to perform at least one function or operation.

When a part, such as a layer, membrane, region, or plate, is described as being “on top of” another part, this includes not only cases where the part is directly on top of the other part, but also cases where there are other parts disposed in between the part and the other part.

In contrast, when an element is referred to as being “directly on” another element, there are no intervening elements present.

In this specification, the term ‘connected’ indicates a physical relationship between two components in which the components are directly connected to each other by welding, rivets, SPR (Self Piercing Rivet), FDS (Flow Drill Screw), structural adhesive, etc., or indirectly connected through one or more intermediate components.

As used herein, ‘vehicle’, ‘vehicular’, ‘automotive’ or other similar terms generally refer to passenger vehicles, sports cars, sport utility vehicles (SUVs), buses, trucks, and various commercial vehicles. Such vehicles also include passenger automobiles, hybrid vehicles, electric vehicles, hybrid electric vehicles, electric vehicle-based PBVs (Purpose Built Vehicles), hydrogen-powered vehicles, and other alternative fuel vehicles (e.g., other than petroleum fuel derived from resources).

In this specification, the ‘front to rear direction’ or ‘length direction’ of the vehicle body may be defined as the longitudinal direction of the vehicle body. The ‘width direction’ may be defined as the left-right or lateral side-to-side direction of the vehicle body. The ‘up-and-down direction’ or ‘vertical direction’ may be defined as the height direction of the vehicle body.

In this specification, an ‘upper end’, ‘upper portion’, or ‘upper surface’ of a component indicates an end, portion, or surface of a component that is relatively upper in the drawing. Further, a ‘lower end’, ‘lower portion’, or ‘lower surface’ of a component indicates an end, portion, or surface of a component that is relatively lower in the drawing.

Furthermore, in this specification, an end of a component (e.g., one end or another (other) end, etc.) denotes an end of a component in any one direction. Also, an end portion of the component (e.g., one end portion) or other (another) end portion, etc.) denotes a portion of a component that includes that end.

Embodiments are hereinafter described in detail with reference to the accompanying drawings.

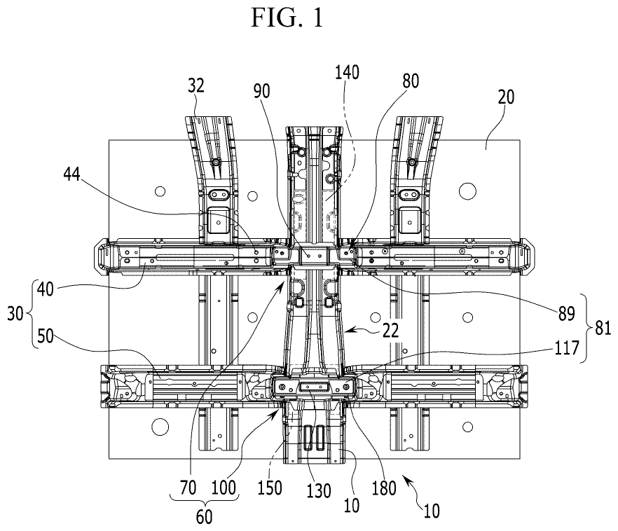

FIG. 1 is a top plan view of a center seat mounting structure according to an embodiment.

Referring to FIG. 1, a center seat mounting structure according to an embodiment may include a floor panel 20 on which a tunnel portion 22 is formed or provided in a length direction of a vehicle body 10. Seat cross members 30 may be respectively arranged on the floor panel 20 in a width direction of the vehicle body 10 on both sides of the tunnel portion 22. Connecting members 60 connecting the seat cross members 30 may be formed or provided on both sides and may form or define a center seat mounting portion 81.

On both sides of the tunnel portion 22 on a front of the floor panel 20, a floor member 32 connected to a dash panel (not shown) is mounted in the length direction of the vehicle body 10, thereby increasing the length direction strength of the vehicle body 10.

The tunnel portion 22 may be formed or provided along the length direction of the vehicle body 10 between the floor members 32.

The seat cross member 30 may include a front seat cross member 40 arranged on both sides of the tunnel portion 22 in the front or forward position of the vehicle body 10. The seat cross member 30 may also include a rear seat cross member 50 arranged on both sides of the tunnel portion 22 at a position rearward of the front seat cross member 40.

The connecting members 60 may include a front connecting member 70 connecting the front seat cross members 40 on both sides and may include a rear connecting member 100 connecting the rear seat cross members 50 on both sides.

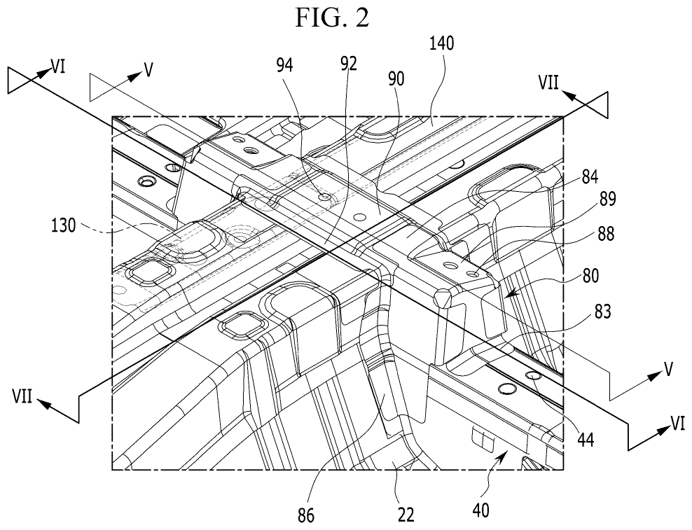

FIG. 2 is a perspective view of a front of a center seat mounting structure according to an embodiment.

Referring to FIG. 1 and FIG. 2, the front connecting member 70 may include a center seat front bracket 80 in which a front center seat mounting portion 89 is formed and connected to the front seat cross members 40 on both sides.

A center seat mounting portion 81 includes the front center seat mounting portion 89 and a rear center seat mounting portion 117 described below. A center seat (not shown) may be mounted on the front center seat mounting portion 89 and the rear center seat mounting portion 117.

The front connecting member 70 is arranged in the width direction of the vehicle body 10 to support the center seat front bracket 80 and may further include a center seat front reinforcement 90 connected to a tunnel reinforcement 130 described later.

The center seat front bracket 80 may include a front bracket lower flange 83 formed or provided to extend in an outward or width direction to be connected with the front seat cross member 40. The center seat front bracket 80 may also include a front bracket upper flange 84 formed or provided to extend in an inward direction to be connected with the center seat front reinforcement 90. The center seat front bracket 80 may further include a front bracket connecting flange 86 formed or provided to extend in a length direction of the vehicle body 10 to be connected with the tunnel portion 22.

A front bracket hole 88 is formed or provided in the front center seat mounting portion 89 for mounting a center seat (not shown).

A front seat mounting hole 44 is formed or provided in the front seat cross member 40 so that a driver's seat or side, i.e., passenger, seat (not shown) may be mounted through the front seat mounting hole 44.

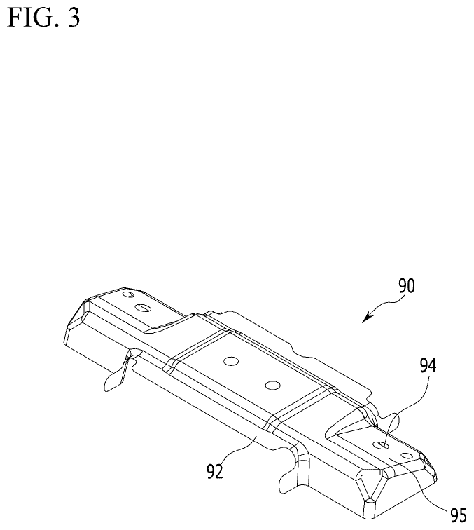

FIG. 3 is a perspective view of a center seat front reinforcement that may be applied to or used in a center seat mounting structure according to an embodiment.

Referring to FIGS. 1-3, the center seat front reinforcement 90 includes a front reinforcement flange 92 connected with a tunnel reinforcement 130 as described below, a front reinforcement hole 94 communicating with the front bracket hole 88, and a mounting support portion 95 formed to support the front center seat mounting portion 89.

The center seat front reinforcement 90 is shown to be mounted on the inside of the center seat front bracket 80, but it is not limited to this configuration. Conversely, the center seat front reinforcement 90 may be mounted on the outside of the center seat front bracket 80.

The center seat front bracket 80 is depicted as two separate components, but it is not limited to this configuration and may also be formed as a single integral component.

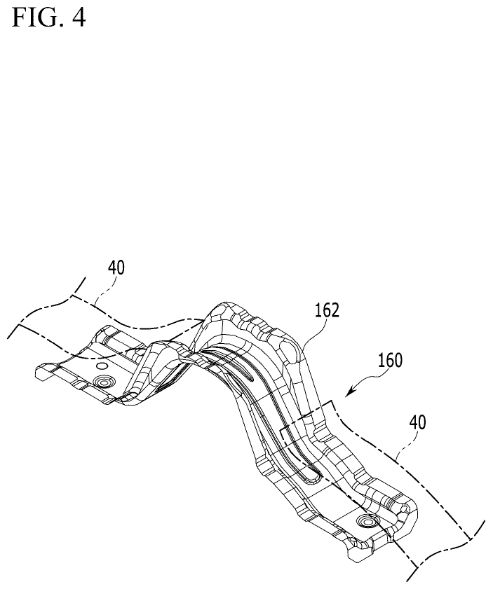

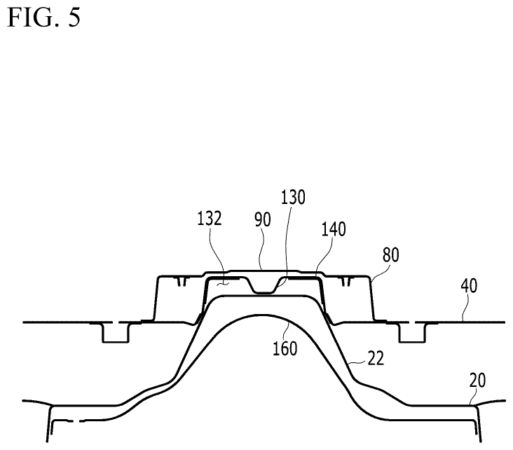

FIG. 4 is a perspective view of a front tunnel brace that may be applied to or used in a center seat mounting structure according to an embodiment. FIG. 5 is a cross-sectional view along line V-V of the center seat mounting structure of FIG. 2.

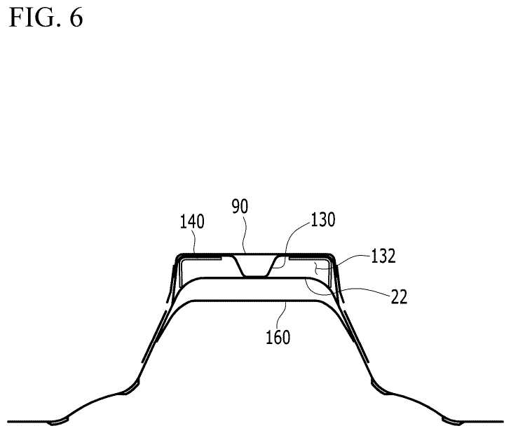

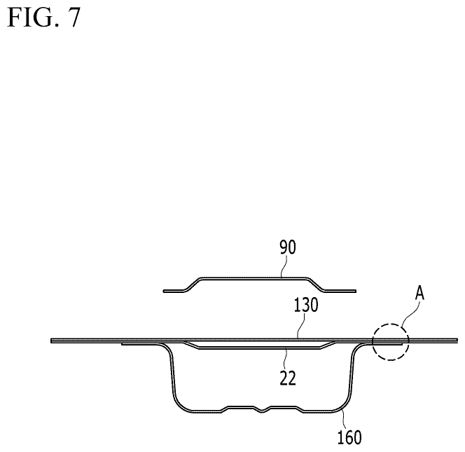

FIG. 6 is a cross-sectional view along line VI-VI of the center seat mounting structure of FIG. 2. FIG. 7 is a cross-sectional view along line VII-VII of the center seat mounting structure of FIG. 2.

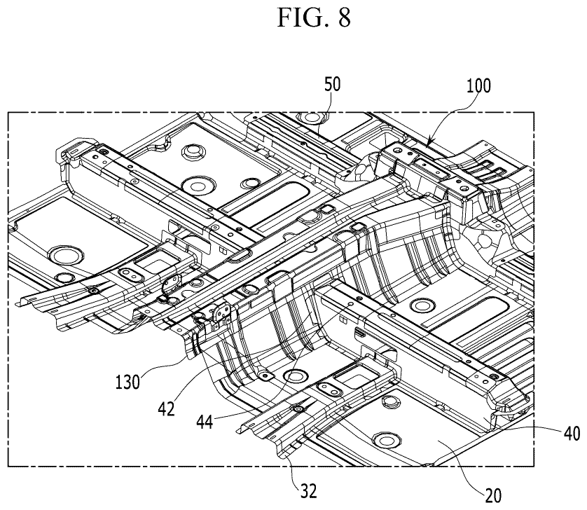

FIG. 8 is a partial perspective view of a front portion of a center seat mounting structure according to an embodiment.

Referring to FIGS. 1-8, the center seat mounting structure according to an embodiment may further include the tunnel reinforcement 130 arranged in the length direction of the vehicle body 10 on top of the tunnel portion 22 to form or define a tunnel portion closed space 132 with the tunnel portion 22.

The tunnel portion closed space 132 formed between the tunnel reinforcement 130 and the tunnel portion 22 may increase the strength of the vehicle body 10 in the length direction.

The tunnel reinforcement 130 may extend from a dash panel (not shown) at the front of the vehicle body to the rear of the floor panel 20.

The center seat mounting structure according to an embodiment may further include a front tunnel patch 140 connected to the tunnel reinforcement 130 to support the center seat front reinforcement 90.

The front tunnel patch 140 is shown as being mounted on both bottom surfaces of the upper side of the tunnel reinforcement 130, but is not limited to this configuration. The front tunnel patch 140 may be formed of or provided as one reinforcement part or three or more reinforcement parts.

The front tunnel patch 140 may extend in a forward direction relative to the front of the vehicle body 10.

For vehicles with a center seat mount, a seat belt retractor for the center seat may be a Belt-in-Seat (BIS) configuration where the seat belt retractor is mounted on the center seat.

When a seat belt retractor for a center seat is mounted on the center seat, the load may be concentrated in the seat mounting configuration.

According to an embodiment, the center seat mounting structure may disperse a load by allowing the front tunnel patch 140 supporting the center seat front reinforcement 90 to extend in the forward direction relative to the front of the vehicle body 10. The center seat is thereby prevented from being detached due to damage to the tunnel portion 22, etc., and thereby satisfies regulations regarding seat belt anchors.

The center seat mounting structure according to an embodiment may further include a front tunnel brace 160, which is positioned at the lower portion of the tunnel portion 22, connects the lower portions of both sides of the tunnel portion 22, and is positioned in the same width direction phase as the front seat cross member 40.

The same width direction phase as the front seat cross member 40 may be defined as the overlap of the front seat cross member 40 and the front tunnel brace 160 in the height direction of the vehicle body 10.

The front tunnel brace 160 includes a front tunnel brace flange 162 formed or provided in the length direction of the vehicle body 10 and extending in the width direction of the vehicle body 10.

The front tunnel brace flange 162 is connected to both sides of the tunnel portion 22, and also forms or defines a closed space between the front tunnel brace flange 162 and the tunnel portion 22. This may increase the strength of the vehicle body 10 in the width direction.

Additionally, the front tunnel brace 160 supports the lower part of the center seat front bracket 80 and the center seat front reinforcement 90 so that the mount part of the center seat may be stably supported.

The configuration indicated as “A” in FIG. 7 represents a part in which the front tunnel brace 160, the tunnel portion 22, and the tunnel reinforcement 130 are combined. For example, the front tunnel brace 160, the tunnel portion 22, and the tunnel reinforcement 130 may be welded to stably support the mounting position of the center seat.

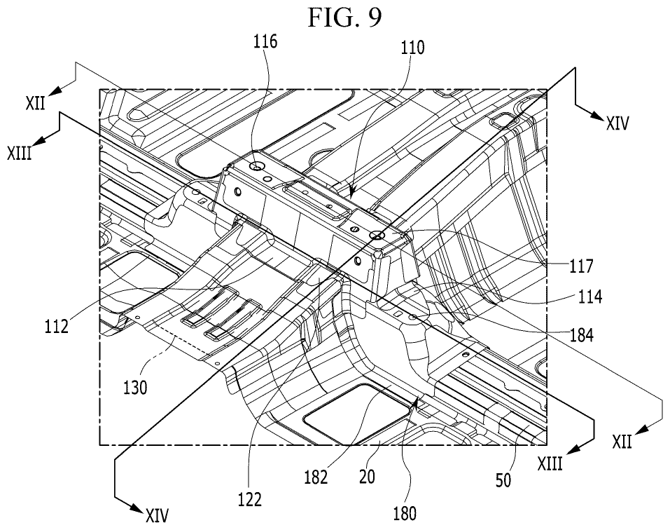

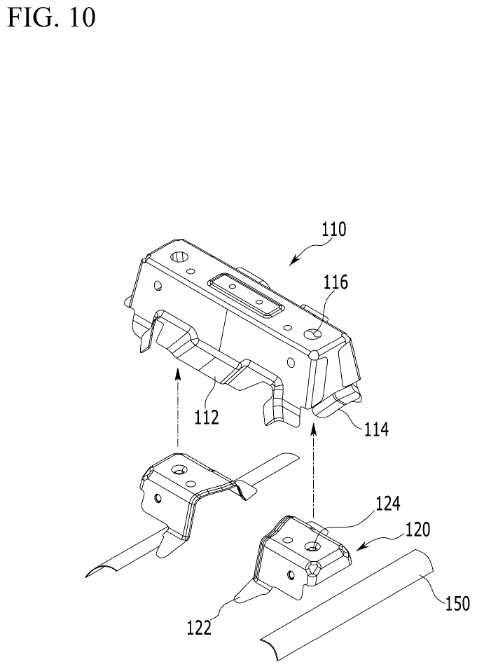

FIG. 9 is a perspective view of a front portion of a center seat mounting structure according to an embodiment. FIG. 10 is a partial exploded perspective view of a front portion of a center seat mounting structure according to an embodiment.

Referring to FIG. 1, FIG. 9, and FIG. 10, the rear connecting member 100 may further include a center seat rear member 110 arranged on the tunnel reinforcement 130, on which the rear center seat mounting portion 117 is formed or provided, and connecting the rear seat cross members 50 on both sides.

A center seat mount guide hole 116 may be formed in the center seat rear member 110.

The center seat mount guide hole 116 is configured to guide the mounting position of the center seat when mounting a center seat (not shown).

The position protrusion of the center seat is inserted into the center seat mount guide hole 116 to limit the position of the center seat and increase production efficiency.

The center seat mounting structure according to an embodiment may further include a rear seat bracket 180 connecting the center seat rear member 110 and the rear seat cross member 50.

The rear seat bracket 180 may be connected to wrap around the rear seat cross member 50.

Additionally, the rear seat bracket 180 may be formed with a rear seat bracket flange 182 that is connected to the floor panel 20 and the tunnel reinforcement 130.

A rear seat bracket mounting hole 184 is formed in the rear seat bracket 180. A driver's seat or side seat (not shown) may be mounted through the rear seat bracket mounting hole 184.

The rear connecting member 100 may further include a center seat rear reinforcement 120 that supports the center seat rear member 110.

The center seat rear member 110 may include a center seat rear member lower flange 112 formed or provided to be connected to the tunnel reinforcement 130 and may include a center seat rear member side flange 114 formed or provided to be connected to the rear seat bracket 180.

The center seat rear reinforcement 120 is connected to the lower part of the center seat rear member 110 and may support the center seat rear reinforcement 120.

The center seat rear reinforcement 120 includes a center seat rear reinforcement flange 122 formed or provided to be connected to the tunnel reinforcement 130 and a guide burring 124 formed or provided inside the center seat mount guide hole 116.

The guide burring 124 may limit the position of the center seat together with the center seat mount guide hole 116 to increase production efficiency.

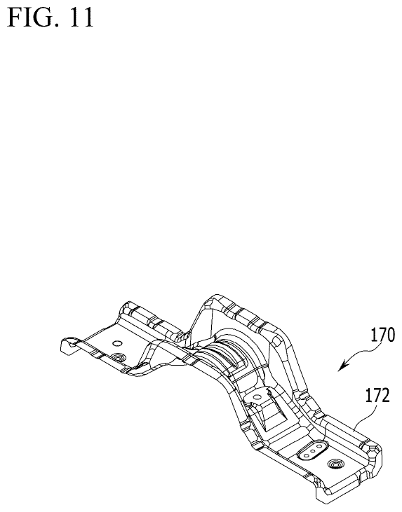

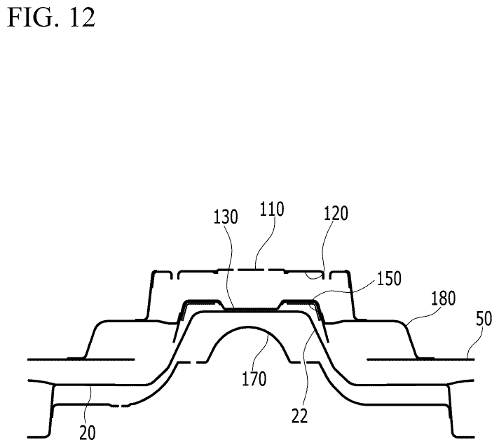

FIG. 11 is a perspective view of a rear tunnel brace that may be applied to or used in a center seat mounting structure according to an embodiment. FIG. 12 is a cross-sectional view along line XII-XII of the center seat mounting structure of FIG. 9.

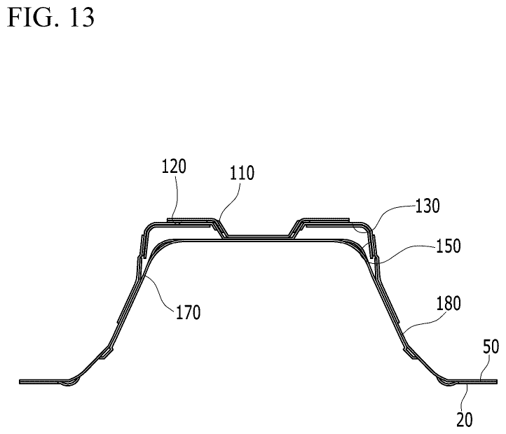

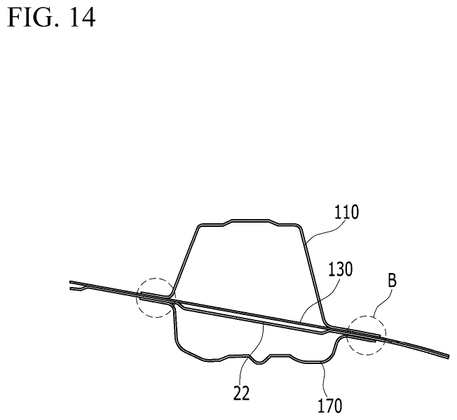

FIG. 13 is a cross-sectional view along line XIII-XIII of the center seat mounting structure of FIG. 9. FIG. 14 is a cross-sectional view along line XIV-XIV of the center seat mounting structure of FIG. 9.

Referring to FIGS. 9-14, the center seat mounting structure may further include a rear tunnel patch 150 connected to the tunnel reinforcement 130 to support the center seat rear member 110.

The rear tunnel patch 150 extends beyond the longitudinal length of the center seat rear member 110 and may be positioned or oriented in the length direction of the vehicle body 10.

Although the rear tunnel patch 150 is depicted as being mounted on the bottom surface of both upper sides of the tunnel reinforcement 130, it is not limited to this configuration. The rear tunnel patch 150 may be formed of or provided as one reinforcement part or three or more reinforcement parts.

According to an embodiment of the center seat mounting structure, the rear tunnel patch 150 supporting the center seat rear member 110 may extend in the length direction of the vehicle body 10 to disperse the load. The center seat is thereby prevented from being detached due to damage to the tunnel portion 22, etc., and thereby satisfies regulations regarding seat belt anchors.

A center seat mounting structure according to an embodiment may further include a rear tunnel brace 170 that is arranged at the lower portion of the tunnel portion 22, connects both lower portions of the tunnel portion 22, and is arranged in the same width direction phase as the rear seat cross member 50.

The rear tunnel brace 170 includes a rear tunnel brace flange 172 formed or provided in the length direction of the vehicle body 10 and extending in the width direction of the vehicle body 10.

The rear tunnel brace flange 172 is connected to both sides of the tunnel portion 22 and also forms or defines a closed space between the rear tunnel brace flange 172 and the tunnel portion 22. This may increase the strength of the vehicle body 10 in the width direction.

Additionally, the rear tunnel brace 170 supports the lower part of the center seat rear member 110 and the center seat rear reinforcement 120 so that the mount part of the center seat may be stably supported.

The view “B” shown in FIG. 14 represents a portion where the rear tunnel brace 170, the tunnel portion 22, the tunnel reinforcement 130, and the center seat rear member 110 are joined. For example, the rear tunnel brace 170, the tunnel portion 22, the tunnel reinforcement 130, and the center seat rear member 110 are welded to stably support the mounting position of the center seat.

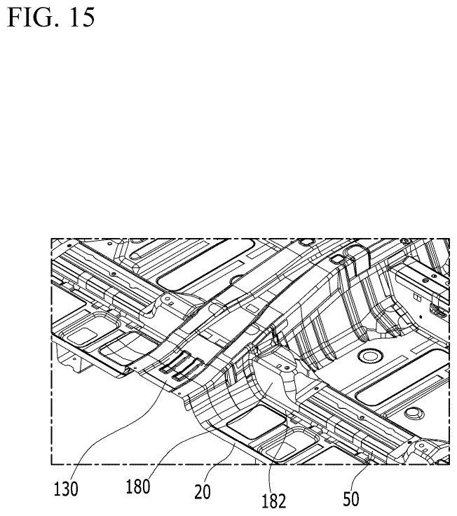

FIG. 15 is a partial perspective view of a rear portion of a center seat mounting structure according to an embodiment.

The center seat mounting structure according to an embodiment may minimize a separate member for mounting the center seat.

In other words, the center seat mounting structure according to an embodiment may reduce cost and weight by using a general first row 2-seater vehicle body platform structure and by employing or requiring a minimum number of separate members.

For example, a vehicle can be produced in which the center seat is not mounted or installed in the first row of seats through the configuration of the front portion of FIG. 9, which shows a state in which the center seat front bracket 80 and the center seat front reinforcement 90 are not mounted or installed. A vehicle can also be produced in the configuration of the rear portion of FIG. 15, which shows a state in which the center seat rear member 110 and the center seat rear reinforcement 120 are not mounted.

Additionally, it is possible to produce a vehicle without a center seat mounted in the first row without mounting or installing the front tunnel patch 140, the rear tunnel patch 140, the front tunnel brace 160, and the rear tunnel brace 170.

Conversely, to produce a vehicle with a center seat that is mounted or installed, the center seat can be mounted or installed in the first row by mounting or installing the center seat front bracket 80 and the center seat rear member 110.

Additionally, the center seat front reinforcement 90 and the center seat rear reinforcement 120 can be mounted or installed to support the center seat front bracket 80 and the center seat rear member 110.

Additionally, the front tunnel patch 140, the rear tunnel patch 150, the front tunnel brace 160, and the rear tunnel brace 170 can be mounted or installed to support the center seat front bracket 80 and the center seat rear member 110.

As described above, the center seat mounting structure according to an embodiment minimizes the need for a separate member for mounting the center seat and enables the production of a center seat mount vehicle and a vehicle without a center seat.

In addition, the center seat mounting structure according to an embodiment can reduce cost and weight by using a general first row 2-seater vehicle body platform structure and by employing or requiring a minimum number of separate members.

In addition, the center seat mounting structure according to an embodiment can satisfy regulations regarding seat belt anchors by securing the strength of the configuration for mounting the center seat.

Additionally, according to the center seat mounting structure according to an embodiment, a center seat mount is possible with only a minimum number of parts, thereby improving the degree of freedom in seat mounting position and design.

Additionally, according to the center seat mounting structure according to an embodiment, when the center seat is not mounted, the space that can be utilized by the center console can be secured to the maximum extent.

While the technical concepts of this disclosure have been described in connection with what are presently considered to be practical embodiments, it is to be understood that the present disclosure is not limited to the described embodiments. On the contrary, the present disclosure is intended to cover various modifications and equivalent arrangements included within the spirit and scope of the appended claims.

### DESCRIPTION OF SYMBOLS

10: vehicle body 20: floor panel
22: tunnel portion 32: floor member
30: seat cross member
40: front seat cross member
44: front seat mounting hole
50: rear seat cross member
60: connecting member 70: front connecting member
80: center seat front bracket 81: center seat mounting portion
83: front bracket lower flange
84: front bracket upper flange
86: front bracket connecting flange 88: front bracket hole
89: front center seat mounting portion
90: center seat front reinforcement
92: front reinforcement flange 94: front reinforcement hole
95: mounting support portion 100: rear connecting member
110: center seat rear member
112: center seat rear member lower flange
114: center seat rear member side flange
116: center seat mount guide hole
117: rear center seat mounting portion
120: center seat rear reinforcement
122: center seat rear reinforcement flange
124: guide burring 130: tunnel reinforcement
132: tunnel portion closed space 140: front tunnel patch
150: rear tunnel patch
160: front tunnel brace
162: front tunnel brace flange
170: rear tunnel brace
172: rear tunnel brace flange
180: rear seat bracket
182: rear seat bracket flange
184: rear seat bracket mounting hole

What is claimed is:

1. A center seat mounting structure comprising:
a floor panel forming a tunnel portion arranged in a length direction of a vehicle body and forming seat cross members arranged on the floor panel in a width direction of the vehicle body on both sides of the tunnel portion; and
a connecting member that connects the seat cross members on both sides and that forms a center seat mounting portion.

2. The center seat mounting structure of claim 1, wherein the seat cross member comprises:
a front seat cross member arranged on each side of the tunnel portion; and
a rear seat cross member disposed on each side of the tunnel portion and rearward of the front seat cross member relative to the length direction of the vehicle body, and
wherein the connecting member comprises:
a front connecting member connecting the front seat cross members on both sides; and
a rear connecting member that connects the rear seat cross members on both sides.

3. The center seat mounting structure of claim 2, further comprising a tunnel reinforcement arranged in the length direction of the vehicle body on an upper portion of the tunnel portion to form a tunnel portion closed space together with the tunnel portion.

4. The center seat mounting structure of claim 3, wherein the front connecting member comprises a center seat front bracket in which a front center seat mounting portion is provided and connected to the front seat cross members on both sides.

5. The center seat mounting structure of claim 4, wherein the front connecting member further comprises a center seat front reinforcement that is arranged in the width direction of the vehicle body to support the center seat front bracket and that is connected to the tunnel reinforcement.

6. The center seat mounting structure of claim 5, further comprising a front tunnel patch connected to the tunnel reinforcement and supporting the center seat front reinforcement.

7. The center seat mounting structure of claim 5, wherein the front tunnel patch extends in the forward direction relative to a front of the vehicle body.

8. The center seat mounting structure of claim 2, further comprising a front tunnel brace, disposed at a lower part of the tunnel portion, connecting lower parts of both sides of the tunnel portion, and placed in the same width direction phase as the front seat cross member.

9. The center seat mounting structure of claim 3, wherein the rear connecting member further comprises a center seat rear member, which is disposed on the tunnel reinforcement, to which a rear center seat mounting portion is formed, and to which the rear seat cross members on both sides are connected.

10. The center seat mounting structure of claim 9, wherein the center seat rear member has a center seat mount guide hole.

11. The center seat mounting structure of claim 9, further comprising a rear seat bracket connecting the center seat rear member and the rear seat cross member.

12. The center seat mounting structure of claim 9, wherein the rear connecting member further comprises a center seat rear reinforcement supporting the center seat rear member.

13. The center seat mounting structure of claim 9, further comprising a rear tunnel patch connected to the tunnel reinforcement to support the center seat rear member.

14. The center seat mounting structure of claim 13, wherein the rear tunnel patch extends beyond a longitudinal length of the center seat rear member and is oriented in the length direction of the vehicle body.

15. The center seat mounting structure of claim 2, further comprising a rear tunnel brace that is positioned at a lower portion of the tunnel portion, connects lower portions of both sides of the tunnel portion, and is positioned in the same width direction phase as the rear seat cross member.
